(19) United States
(12) Patent Application Publication
(10) Pub. No.: US 2007/0115255 A1
(43) Pub. Date: May 24, 2007

(54) Mobile device

(75) Inventor: Long Jyh Pan, Sijhih (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/555,805

(22) Filed: Nov. 2, 2006

(30) Foreign Application Priority Data
Nov. 3, 2005 (TW) TW94138547

(51) Int. Cl. G09G 5/00

(52) U.S. Cl. 345/156

(57) ABSTRACT

A mobile device comprises a first module and a second module connected to the first module. The second module relatively sliding along an X-axis with respect to the first module comprises a display module rotatable around a Y-axis perpendicular to the X-axis.

### BACKGROUND OF THE INVENTION

1. Field of the Invention

The invention relates to a mobile device, and in particular to a mobile device with a lifting and sliding cover for optimizing the structure and space thereof.

2. Description of the Related Art

With the rapid progress in mobile devices, cell phones, calculators, personal digital assistants (PDA) and notebooks, technology has led to the development of various types of various phones, such as bar, lifting-cover and sliding-cover types have been introduced to and have multiple functions such as picture-taking, good communication quality, simple control interfaces, power saving, large-size screen and modern appearance.

A sliding-cover mobile phone with a fixed display panel or screen, however, causes limitations on the development of a housing or case thereof, in particular thin and light mobile phones.

### BRIEF SUMMARY OF THE INVENTION

A detailed description is given in the following embodiments with reference to the accompanying drawings.

The invention provides a mobile device with a lifting and sliding cover for optimizing the structure and space thereof. The mobile device comprises a first module and a second module connected to the first module. The second module slides along an X-axis with respect to the first module and comprises a display module rotatable around a Y-axis perpendicular to the X-axis.

The first module comprises a first housing and a first keyboard disposed on the first housing, the second module comprises a second housing slidably connected to the first housing and a second keyboard. The display module is pivoted to the second housing.

The mobile device further comprises a hinge pivoted to the second housing and the display module. The hinge is perpendicular to the second housing.

The first housing comprises a first slot and the second housing comprises an opening. The hinge passing through the first slot and the opening slides along the first slot together with the second module, and the hinge is disposed between the first and second modules.

The mobile device further comprises an electrical connecting element disposed between the first and second modules.

The hinge comprises a first cam fixed to the display module and a second cam fixed to the second housing, wherein the first cam and the second cam contact each other.

The hinge further comprises an elastic element exerting an elastic force on the second cam.

The first housing comprises a second slot and the second housing comprises a rail slidably connected to the second slot.

The first housing further comprises an elastic arm disposed on a first end of the second slot, and the elastic arm is for stopping the rail from sliding as the rail slides to the first end of the second slot.

The first keyboard comprises a primary keyboard region having a plurality of alphabetic keys and numeric keys and a secondary keyboard region having a plurality of alphabetic keys and numeric keys. The second keyboard comprises a plurality of function keys.

The first module further comprises a third housing and a circuit board disposed between the first housing and the third housing. The first housing and the third housing are integrally formed.

The second module further comprises a receiver disposed in the second housing. The second module is slidable between a first position and a second position and the first keyboard of the first module further comprises a primary keyboard region and a secondary keyboard region, and the secondary keyboard region of the first keyboard is exposed to the second module when the second module is located at the second position.

The display module of the second module is rotatable between a third position and a fourth position. The primary keyboard region of the first keyboard is exposed to the second module when the display module is located at the fourth position.

The mobile device comprises an electrical connecting element electrically connected to the first and second modules to transmit signals. The electrical connecting element comprises a flexible printed circuit board or a cable.

The mobile device can be a cell phone, a calculator, a personal digital assistant or a notebook computer.

### BRIEF DESCRIPTION OF THE DRAWINGS

The invention can be more fully understood by reading the subsequent detailed description and examples with references made to the accompanying drawings, wherein:

FIG. 1A is a schematic view of a mobile device (100), wherein the mobile device (100) is in a closed mode;

FIG. 1B is a schematic view of the mobile device (100) deployed in a sliding situation;

FIG. 1C is a schematic view of the mobile device (100) deployed in a rotating situation;

FIG. 1D is a schematic view of the mobile device (100) deployed in a rotating situation;

FIG. 2 is an exploded view of a first module (10) of the mobile device (100);

FIG. 3 is an exploded view of a second module (20) of the mobile device (100)

FIG. 4 is an exploded view of a first module (10) of the mobile device (100);

FIG. 5 is a schematic view of an assembly of a second module (20), a hinge (30) and an electrical connecting element (50); and

FIG. 6 is a rear view of a first module (10) and a second module (20) of the mobile device (100).

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

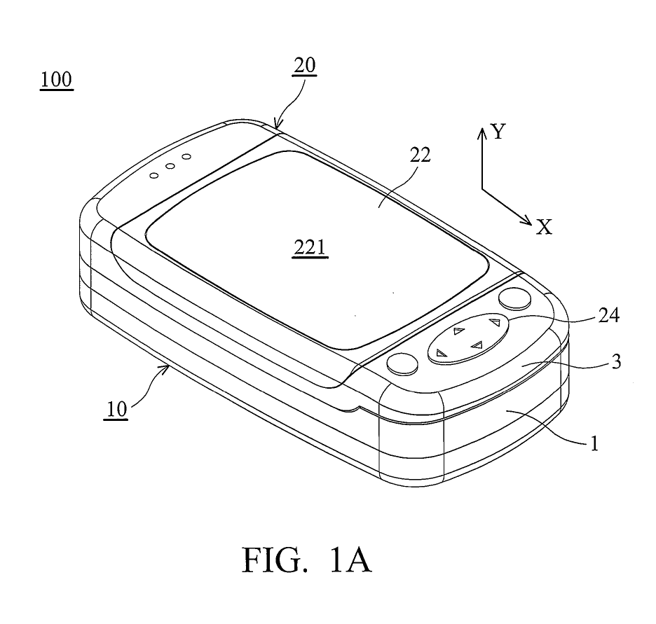

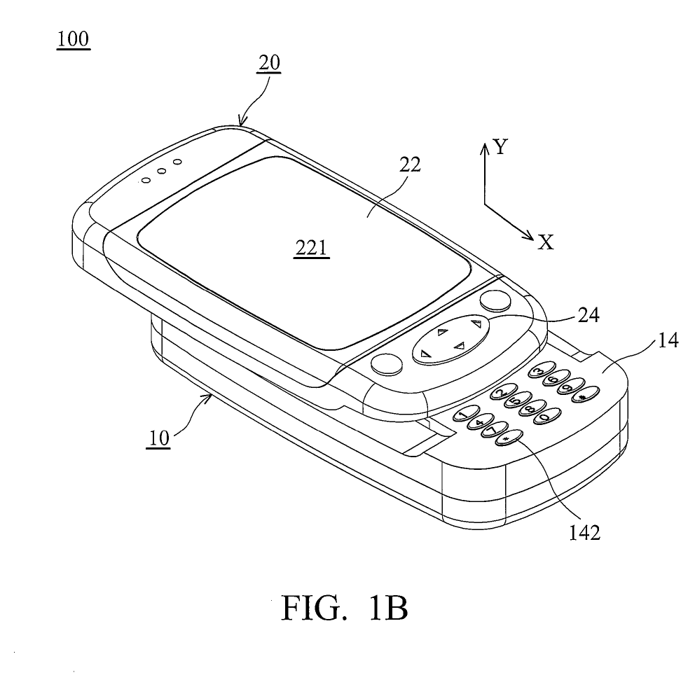

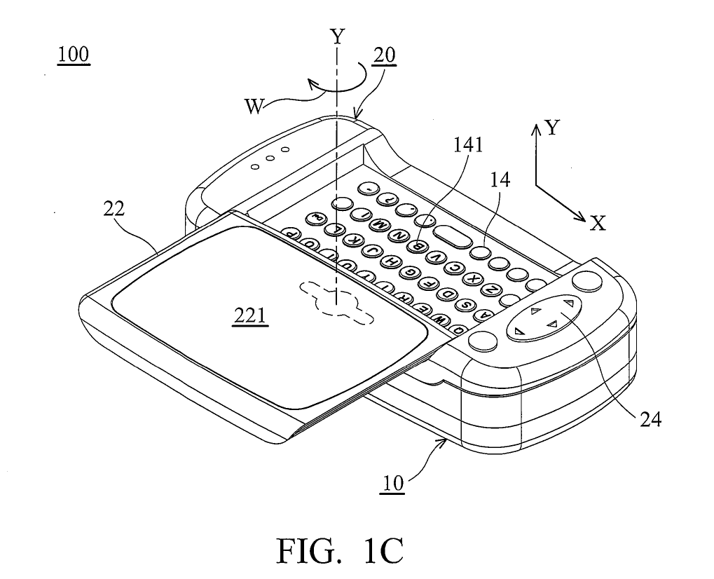

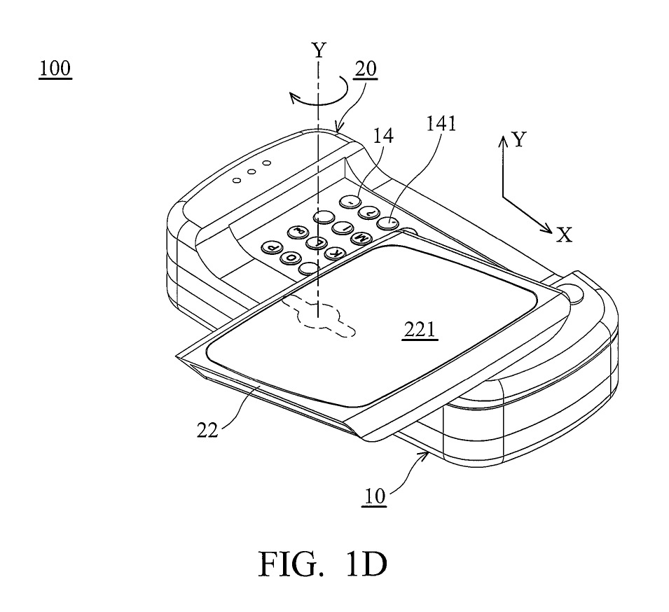

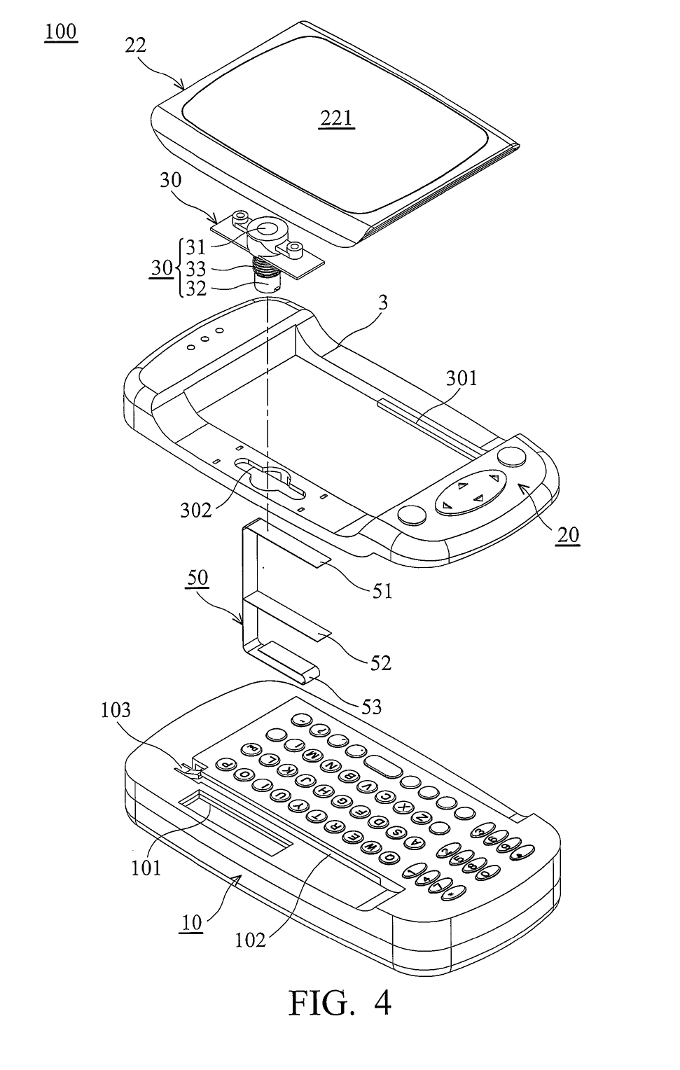

In FIGS. 1A and 1B, a mobile device 100 of the invention, such as a cell phone, comprises a first module 10, a second module 20 connected to the first module 10 and having a panel 221, a hollow hinge 30 (shown in FIG. 4) disposed on the second module 20 and an electrical connecting element 50 (shown in FIG. 4). The second module 20 is slidable along an X-axis with respect to the first module 10 between a first position (FIG. 1A, a closed mode) and a second position (FIG. 1B, a sliding mode). The second module 20 comprises a display module 22 rotatable around a Y-axis between a third position (FIG. 1A) and a fourth position (FIG. 1C). The X-axis is perpendicular to the Y-axis, and the hinge 30 is substantially perpendicular to the second housing 3. In this embodiment, the mobile device 100 can be a calculator, a personal digital assistant or a notebook computer.

The first module 10 comprises a first housing 1 and a first keyboard 14, disposed on the first housing 1. The first keyboard 14 has a primary keyboard region 141 and a secondary keyboard region 142 having a plurality of alphabetic keys and numeric keys, respectively. The number of keys in the primary keyboard region 141 is larger than that in the secondary keyboard region 142.

The second module 20 comprises the display module 22, a second keyboard 24 and a second housing 3 slidably connected to the first housing 1. The second keyboard 24 and the display module 22 are pivoted to the second housing 3. In FIG. 1A or the closed mode (first position), only the second keyboard 24 can be operated. In FIG. 1B or the sliding mode (second position), the secondary keyboard region 142 of the first keyboard 14 is exposed to the second module 20 when the second module 20 is located at the second position.

In FIG. 1C (fourth position), the display module 22 rotatable around the Y-axis is opened along the direction of an arrow w. The primary keyboard region 141 of the first keyboard 14 is exposed to the second module 20 when the display module 22 is located at the fourth position. In FIG. 1D, the display module 22 is substantially deployed at the middle of the third position (FIG. 1A) and a fourth position (FIG. 1C).

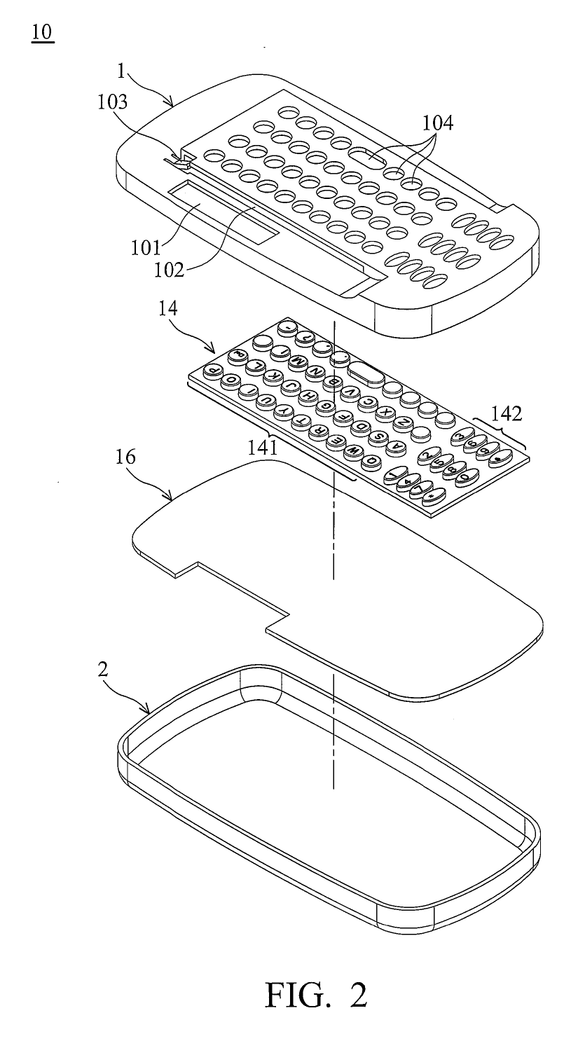

In FIG. 2, except for the first housing 1 and the first keyboard 14, the first module 10 further comprises a third housing 2 and a circuit board 16. The first and third housings 1 and 2 are respectively the upper and lower parts of the first module 10. The first keyboard 14 and the circuit board 16 electronically connected to the first keyboard 14 are disposed between the first housing 1 and the third housing 2. The first housing 1 comprises a first slot 101, a second slot 102, an elastic arm 103 and a plurality of through holes 104. The elastic aim 103 is disposed on a first end of the second slot 102. The through holes 104 are formed with respect to the keys of the first keyboard 14. In other embodiments, the first housing 1 and the third housing 2 can be integrally formed.

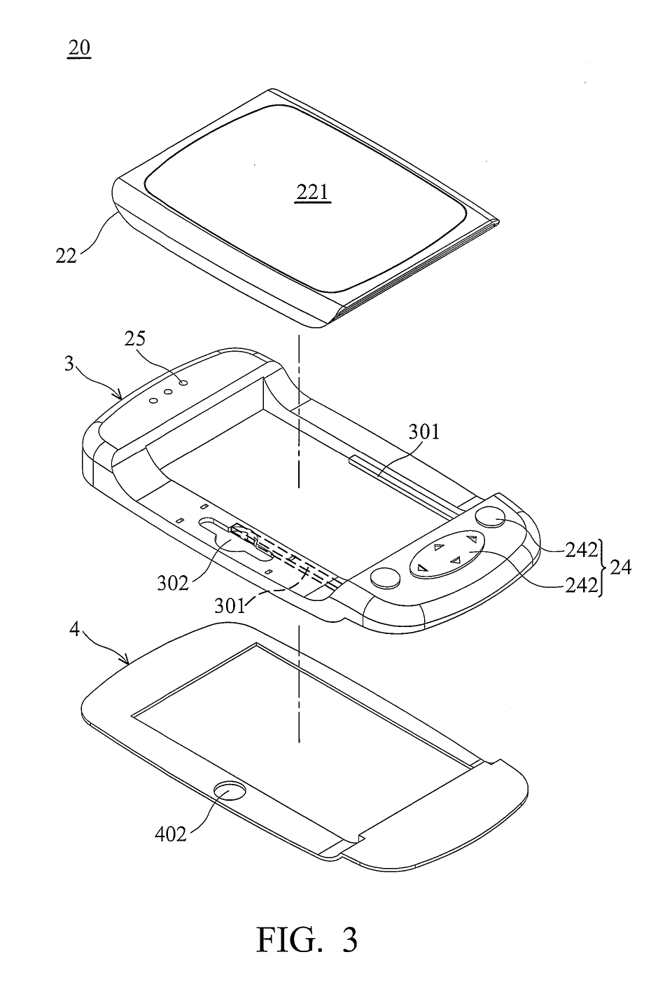

In FIG. 3, except for the display module 22, the second keyboard 24 and the second housing 3, the second module 20 further comprises a receiver 25 disposed in the second housing 3 and a fourth housing 4 assembled to the second housing 3. The second and fourth housings 3 and 4 are two individual elements, and the assembly of the second and fourth housings 3 and 4 are slidably connected to the first housing 1 of the first module 10. In FIGS. 4 to 6, the display module 22 is rotatably connected to the second housing 3 by the hinge 30. The second keyboard 24 disposed on the second housing 3 comprises a plurality of function keys 242. The second housing 3 comprises a rail 301 corresponding to the second slot 102 and an opening 302 designed according to the size of the hinge 30.

The hinge 30 disposed between the first and second modules 10 and 20 passes through the first slot 101. The opening 302 slides along the first slot 101 together with the second module 20. The elastic arm 103 prevents the rail 301 from sliding as the rail 301 slides to the first end of the second slot 102.

The hinge 30 comprises a first cam 31 fixed to the display module 22, a second cam 32 contacting the first cam 31 and fixed to the second housing 3 and an elastic element 33. In this embodiment, the first and second cams 31 and 32 can be fixed by screws, hooks or other connecting parts. The first and second cams 31 and 32 are two conventional cams having two different curved surfaces. The first and second cams 31 and 32 can be snugly fitted to each other or can be relatively rotated. When the first and second cams 31 and 32 are relatively rotated, the elastic element 33 begins to exert an elastic force on the second cam 32, causing the first and second cams 31 and 32 being snugly fitted.

Due to the rail 301 of the second housing 3 slidably connected to the second slot 102, the second module 20 and the first module 10 can be relatively moved. The fourth housing 4 comprises a through hole 402 for receiving the hinge 30. In FIGS. 1A and 2, the elastic arm 103 prevents the second module 20 from sliding out of the first module 10 when the second module 20 slides into the first module 10. In other embodiments, the second and fourth housings 3 and 4 can be integrally formed, or the fourth housing 4 can be eliminated.

In FIG. 4, the electrical connecting element 50 comprises three spaced cantilevered portions 51, 52 and 53, to respectively connect to the display module 22, the first module 10 and the second module 20 and to transmit signals therebetween. In this embodiment, the electrical connecting element 50 can be a flexible printed circuit board (FPCB) or cable connector.

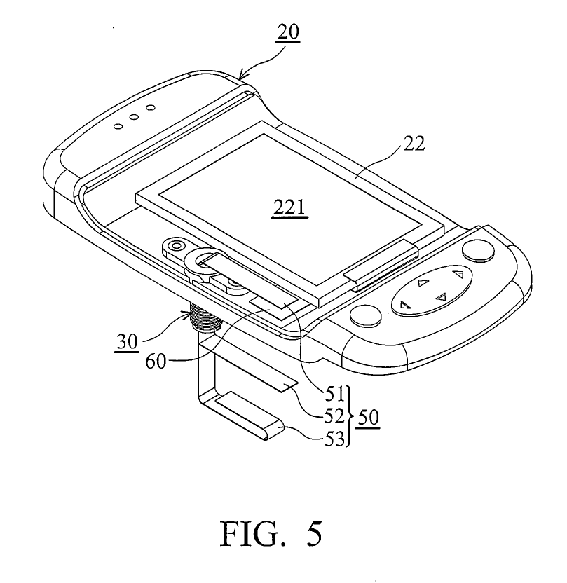

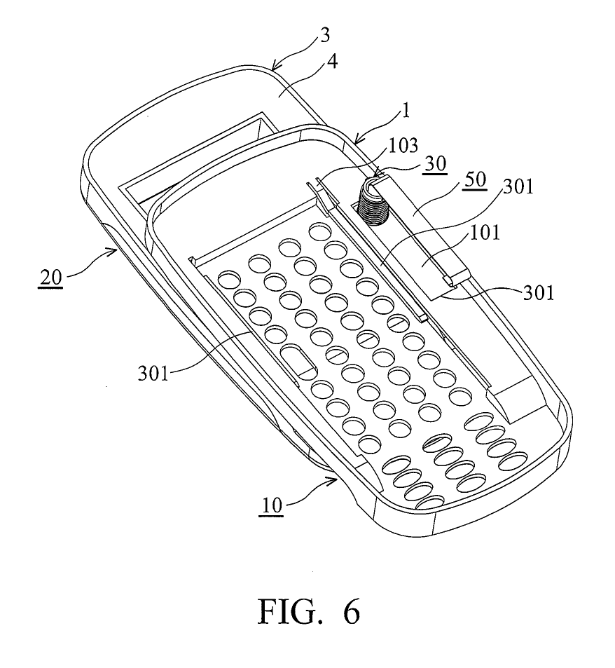

In FIGS. 5 and 6, the hinge 30 and the electrical connecting element 50 passing through the hinge 30 passes through the opening 302, the through hole 402 of the fourth housing 4 (shown in FIG. 3) and the first slot 101 of the first module 10, to connect the first and second modules 10 and 20. In FIG. 5, the outer case of the display module 22 and the first module 10 are omitted, to clearly show the connection of the second module 20, the panel 221 of the display module 22 and the hinge 30. Note that a board to board (B/B) connector or a FPCB 60 can be further provided to electrically connect to the panel 221 of the display module 22 and the cantilevered portion 51 of the electrical connecting element 50.

In FIG. 6, after connecting the second housing 3 to the fourth housing 4, hinge 30, passing through the opening 302, the through hole 402 of the fourth housing 4 and the first slot 101 of the first module 10, is connected to the first and second modules 10 and 20. Note that the keyboard of the first housing 1 is omitted and the opening 302 and the through hole 402 of the fourth housing 4 cannot be seen, to clearly show the rail 301 of the second module 20 in FIG. 6. The elastic arm 103 prevents the second module 20 from sliding as the rail 301 of the second module 20 slides to the first end of the second slot 102.

In FIG. 1A, the second keyboard 24 of the mobile device 100 situated in closed mode is used to answer the call, without having to slide or open the second module 20. In FIG. 1B, the secondary keyboard region 142 exposed by sliding the second module 20 along the X-axis can be used to dial. In FIG. 1D, by rotating the primary keyboard region 141 of the first keyboard 14 on the Y-axis and passing through the space onto the secondary keyboard region 142, the primary keyboard region 141 can be used for data input.

Thus, the invention is a remarkable and effective design that decreases the actual volume and cost of the mobile device 100, facilitates the assembly process and simplifies operation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device (100), comprising
a first module (10); and
a second module (20), connected to the first module, (10) slidable along an X-axis with respect to the first module (10), the second module comprising a display module (22) rotatable around a Y-axis, the Y-axis being perpendicular to the X-axis.

2. The mobile device (100) as claimed in claim 1, wherein the first module (10) comprises a first housing (1) and a first keyboard (14) disposed on the first housing (1), the second module (20) comprises a second housing (3) slidably connected to the first housing (1) and a second keyboard (24), and the display module (22) is pivoted to the second housing (3).

3. The mobile device (100) as claimed in claim 2 further comprising a hinge (30) pivoted to the second housing (3) and the display module (22), wherein the hinge (30) is perpendicular to the second housing (3).

4. The mobile device (100) as claimed in claim 3, wherein the first housing (1) comprises a first slot (101) and the second housing (3) comprises an opening (302), wherein the hinge (30), passing through the first slot (101) and the opening (302), slides along the first slot (101) together with the second module (20), and the hinge (30) is disposed between the first and second modules (10 and 20).

5. The mobile device (100) as claimed in claim 4 further comprising an electrical connecting element (50) disposed between the first and second modules (10 and 20) through the hinge (30), the electrical connecting element (50) electrically connected to the first and second modules (10 and 20).

6. The mobile device (100) as claimed in claim 3, wherein the hinge (30) comprises a first cam (31) fixed to the display module (22) and a second cam (32) fixed to the second housing (3), wherein the first cam (31) and the second cam (32) contact each other.

7. The mobile device (100) as claimed in claim 6, wherein the hinge (30) further comprises an elastic element (33) exerting an elastic force on the second cam (32).

8. The mobile device (100) as claimed in claim 2, wherein the first housing (1) comprises a second slot (102) and the second housing (3) comprises a rail (301) slidably connected to the second slot (102).

9. The mobile device (100) as claimed in claim 8, wherein the first housing (1) further comprises an elastic arm (103) disposed on a first end of the second slot (102), and the elastic arm (103) is for stopping the rail (301) from sliding as the rail (301) slides to the first end of the second slot (102).

10. The mobile device (100) as claimed in claim 2, wherein the first keyboard (14) comprises a primary keyboard region (141) having a plurality of alphabetic keys and numeric keys and a secondary keyboard region (142) having a plurality of alphabetic keys and numeric keys.

11. The mobile device (100) as claimed in claim 2, wherein the second keyboard (24) comprises a plurality of function keys (242).

12. The mobile device (100) as claimed in claim 2, wherein the first module (10) further comprises a third housing (2) and a circuit board (16) disposed between the first housing (1) and the third housing (2).

13. The mobile device (100) as claimed in claim 12, wherein the first housing (1) and the third housing (2) are integrally formed.

14. The mobile device (100) as claimed in claim 2, wherein the second module (20) further comprises a receiver (25) disposed in the second housing (3).

15. The mobile device (100) as claimed in claim 2, wherein the second module (20) is slidable between a first position and a second position and the first keyboard (14) further comprises a primary keyboard region (141) and a secondary keyboard region (142), and the secondary keyboard region (142) of the first keyboard (14) is exposed to the second module (20) when the second module (20) is located at the second position.

16. The mobile device (100) as claimed in claim 15, wherein the display module (22) of the second module (20) is rotatable between a third position (FIG. 1A) and a fourth position (FIG. 1C), and the primary keyboard region (141)) of the first keyboard (14) is exposed to the second module (20) when the display module (22) is located at the fourth position.

17. The mobile device (100) as claimed in claim 1 further comprising an electrical connecting element (50) electrically connect to the first and second modules (10 and 20) to transmit signals.

18. The mobile device (100) as claimed in claim 17, wherein the electrical connecting element (50) comprises a flexible printed circuit board (FPCB) or a cable.

19. The mobile device (100) as claimed in claim 17, wherein the mobile device (100) comprises a cell phone, a calculator, a personal digital assistant or a notebook computer.
